(19) United States
(12) Patent Application Publication
(10) Pub. No.: US 2009/0291672 A1
(43) Pub. Date: Nov. 26, 2009

(54) System And Method For Providing Personalized Automated And Autonomously Initiated Information Delivery And Chaperone Service

(75) Inventors: Ron Treves, Kfar Saba (IL); Dina Treves, Kfar Saba (IL); David Treves, Palo Alto, CA (US); Benny Schwabsky, Kfar Monash (IL); Haim Granot, Bat Hefer (IL)

Correspondence Address: JAS IP CONSULTING, 309 2nd STREET, SUITE 8, LOS ALTOS, CA, 94022, US

(73) Assignee: Ron Treves, Kfar Saba (IL)

(21) Appl. No.: 12/270,657

(22) Filed: Nov. 13, 2008

Related U.S. Application Data
(60) Provisional application No. 60/988,084, filed on Nov. 14, 2007.

(51) Int. Cl. H04W 4/02; G06F 15/16; G06F 17/30

(52) U.S. Cl. 455/414.1; 709/203; 707/104.1

(57) ABSTRACT

A system and method for receiving travel information such as flight information, directional guidance to airport gates and facilities, and interacting autonomously with service providers such as airlines and rental car companies without requiring human resources to receive the tickets or car keys. The system devices essentially provide an automatic chaperon which can initiate processes such as querying databases or provide navigation guidance without intervention, setup procedures or any prior knowledge on behalf of the user. It can also access secured databases for retrieving rental car reservation information for automatic rental car checkout, personal health files for emergency cases, flight check-in, connecting flight information and call for emergency staff alerting the staff automatically of the caller's location within the compound, as well as recent health history and condition.

### RELATED APPLICATIONS

The present application is a nonprovisional filing claiming priority to U.S. Prov. Patent Application Ser. No. 60/988,084 filed Nov. 14, 2007, which is incorporated herein by reference.

### BACKGROUND

1. Field

The present invention is related to the field of personal assistance services provided over a wireless infrastructure, and more particularly to methods and apparatus for providing assistance to a user in finding a particular service or service provider.

2. Description of the Prior Art

The present invention relates to a system and method for providing personalized, automated and autonomously initiating information regarding service providers, to individuals such as customers of travel service providers, customers of health service providers, etc. A wide variety of systems are available for providing location and directional assistance information, on demand, to users. Some supply street or topographical navigation guidance, while others utilize computers to display information on monitors, or interactively query search engines to look up requested topics. There are also systems such as Sabre (www.sabreairlinesolutions.com) which provide updates to users' mobile devices with regards to changes in flight schedule.

Existing search engines, and systems such as pocket PCs running navigation software, execute programs that access stored information either from remote locations or from on-board storage devices. These interactive systems require the user not only to initiate the search for a specific topic, but also to demonstrate adequate familiarity with the material at hand to narrow down the search and reach the desired search results. An example of an existing navigation system is OZI Explorer which requires the users to first install the generic portion of the software and then install maps and plan routes and last designate a known location for a destination. Many mapping data web sites, such as Google Maps, are available to provide point to point directions or general regional maps. Such sites require the user to first connect to the internet and access the data provider (e.g., Google), then designate a known location and/or destination. Both of these examples demonstrate the inherent requirement that a user possess some level of knowledge and skill in order to achieve a desired result. Furthermore, the information is supplied only upon user request.

Another category of navigation aids uses GPS for outdoors, and Wi-Fi access points for indoors and outdoors, provide an infrastructure for location-based communication and data transfer for mobile computers, yet all these solutions require human intervention. Again, the user of these tools is required to initiate certain actions, and obtain certain knowledge either pertaining to the actual manipulation and operation of the software or even the technical information relating to the data being sought after.

Another system of interest is known in the art as the Skyhook Wireless Wi-Fi Positioning System. This solution concentrates on positioning algorithms and software for calculating a mobile device's location based upon power measurements from Wi-Fi access points. It addresses the method for determining the mobile device location, but does not deal with the aspect of self-initiating systems generating information and predicting certain required information: be it location or any other type of information.

Additional related systems are disclosed in Published United States Patent Applications Serial No. 20050070304 (“Distributed wireless positioning engine method and assembly” and Serial No. 20070061041 (“Mobile robot with wireless location sensing apparatus”). These patent applications concern the actual hardware and software mechanisms for measuring location between a mobile transmitter and a plurality of receivers using wireless communication. They address the methods for determining the mobile device location and do not deal with the aspect of self-initiating systems generating information and predicting certain required information.

Of additional interest is a system disclosed in “A measurement study of vehicular internet access using in situ Wi-Fi networks,” by Vladimir Bychkovsky, Bret Hull, Allen Miu, Hari Balakrishnan, and Samuel Madden, MIT Computer Science and Artificial Intelligence Laboratory. This work discusses the possibility of using widespread Wi-Fi home networks and business hot spots to create a virtually continuous network. It explores the concept of hopping from one network to another while a mobile device is in motion and does not deal with the aspect of self-initiating systems generating information and predicting certain required information: be it location or any other type of information.

Another related system is known and referred to as the AeroScout Wi-Fi and Active RFID-based Visibility System. This “enterprise visibility solutions” system uses standard Wi-Fi wireless networks to locate and manage assets and people in multiple environments. The system uses RFID tags attached to people or equipment. Some of the tags may be equipped with some form of motion detection for saving power or some other triggering mechanism for tag activation—the tags may be activated when moved, when temperature changes, etc. However, the system does not address the need for nor suggest a system for providing self-initiated information of which relevance is predicted based upon a user's profile and dynamic database of changing information pertaining to the user. Triggering activity or triggering the transfer of information is not like an automated search and distribution of data based upon prediction of required information.

The Ekahau Finder and Tracker product provides positioning solutions for locating people, assets, inventory and other objects using wireless enterprise networks. The Ekahau solution tracks wireless laptops, PDAs, VOIP phones, Wi-Fi tags and other 802.11 enabled devices. It addresses the method for determining the mobile device location, but does not deal with the aspect of self-initiating systems generating information and predicting certain required information. It does not disclose providing self-initiated information of which relevance is predicted based upon a user's profile and dynamic database of changing information pertaining to the user. Furthermore, it does not disclose triggering activity or triggering the transfer of information such as an automated search and distribution of data based upon prediction of required information.

The Pan Go Locator is another solution providing location management and asset tracking software and services. However, it also does not provide self-initiated information of which relevance is predicted based upon a user's profile and dynamic database of changing information pertaining to the user.

Newbury Networks' Location Appliance provides location management and asset tracking software and services, again using an active RFID tag for Wi-Fi. However, once again it does not disclose self-initiated provision of information the relevance of which is predicted based upon a user's profile and a dynamic database of changing information pertaining to the user.

The Sabre Airline Solutions' Sabre Inform Alerting Services provides the ability to send messages to users' mobile devices with updates regarding flight schedule or gate change. This is done once per change of database and is timed with the change in the database regardless of the location of the user and the status of the user in the process of pre-flight procedures. Thus, for example, a user may receive notification regarding a gate change prior to arriving at the airport. In other words the message is sent without any correlation to or awareness of the user's actual status. This solution basically provides an alert system which notifies of a change in a database. It is not a user profile oriented system which follows the user through the process of check-in and boarding a flight with guidance. The message must be received in a timely manner, when it is actually relevant. Furthermore, no contextual information, such as location, about the user is considered when providing updates.

The article “Advanced Integration of WiFi and Inertial Navigation Systems for Indoor Mobile Positioning,” by Frederic Evennou and Francois Marx, Division R&D, TECH/IDEA, France Telecom, 38243 Meylan, France, discusses position location. However, it does not disclose self-initiating software which provides information from a dynamically changing database to a user, based upon time, a user's location and a user's profile.

Finally, the article “Indoor Positioning Using Wireless Local Area Networks,” by Michael Wallbaum and Otto Spaniol, RWTH Aachen University, Department of Computer Science, again discusses position location but does not disclose self-initiating software which provides information from a dynamically changing a database to a user, based upon time, a user's location and a user's profile.

### SUMMARY

Accordingly, the present invention is a system and method for providing client-uninitiated (and optionally) secured wireless access to information of service providers. Most broadly, the invention encompasses any number of tasks or procedures which may be sequenced or scheduled with a well defined starting point and end point to provide an autonomous or semi-autonomous real-time temporal and spatial guidance through such scheduling. The ability to schedule the sequence of operations is based upon temporal and spatial location of the user, a finite number of considerations programmed in advance as a user profile, and inputs serving as triggers from service providers' databases for evaluating the current state of the system. As an abstract example consider the following:
A given perimeter (P) where all tasks and procedures are executed. In this perimeter the location and whereabouts of the user are given.
P is covered by a wireless network (N).
The current time (T) is provided to the system by means of a real time clock.
A finite number of considerations, preferences and characteristics of the user shall be referred herein as the User Profile (UP) and is stored in the system's database.
One or more databases (DB) of service providers contain triggering mechanisms that notify the system of changes made to the databases pertaining to the service requested by the user.
A mobile device (CM) provides a means of communicating messages to the user using (N) and measuring his location within (P).
   Based upon (T), (UP), the location of (CM) and updates from (DB) it is possible to manage and schedule a sequence of tasks or procedures and provide an autonomous real-time guidance through such scheduling.

According to the present invention there is provided a management system that automatically transmits information to a user's mobile (e.g., wireless) device. The transmission of the information may be initiated by the system or in response to very simple queries by the users. The system utilizes monitoring of the location of users within any area covered by the wireless system that communicates with the user's mobile device via a network of wireless access points. The automatically transmitted directives or information may be related to the user's geographical location, the user's status with respect to a scheduled set of actions that need to be taken, or information updates pertaining to the predefined user's profile. This system is connected to at least one database. The system has the ability to uniquely identify the user at any transaction requiring secured authentication and cross reference it with the system.

According to one aspect of the present invention, there is provided a method to initiate communication with the user and provide user specific information, as well as respond to information queries or dispatch an emergency team in response to a user initiated signal of distress. The method of operation of the present invention includes a number of the following steps (which specific steps are included depend on the specific embodiment):
1. A one time operation of registration and authentication to include user information in the system database. For example this information may include I.D. number, driver's license details, finger print scan sample, retina scan sample, personal medical history and health condition, citizenship and other personal details.
2. Define the type of automatically accessed service information by the system.
3. Automatic log-in upon arrival at the site being covered by the wireless system access points.
4. Secured authentication by means of Personal Identification Number or biometric identification may be requested by the system from the user in order to verify and authorize sensitive procedures or transactions. For biometric authentication, a swipe for scanning a finger print or eye retina scan using a scanner on the mobile device or an on-site check-in station will suffice.
5. Monitor the location of the user within the area covered by the wireless system access points.
6. Automatically receive updates from a service provider's database to the system's server.
7. Automatically provide data to the user, such as directions for the user to a default destination based upon existing and valid information pertaining to the user's itinerary.
8. Response to user requested actions:
   a. A query initiated by the user voluntarily, such as when searching direction to the location of a coffee shop, is answered by the system.
   b. An emergency distress signal transmitted by pressing a button, to summon medical attention or security staff to the location of the user.
   c. Automatic distress signal triggered by an auxiliary monitoring device, for example heart pace maker will summon medical staff to the location of the user.

According to another aspect of the present invention, a timely message delivery system based upon the location and status of the user is provided. The system is aware of the location of the user and his travel needs and is able to assess whether the user is about to miss a flight, or direct the user to a newly defined gate. It is not just an alert system but a true chaperone service providing guidance and possibly emergency assistance by being able to seamlessly integrate information from various databases and provide relevant information based upon the current status of the user.

The present invention may have applicability in many areas such as, but not limited to, providing travel service, health services, meeting or appointment planning, material logistics, etc. Accordingly, particular examples of the field of application of the present invention should not be considered a limitation of the scope of the invention but merely illustrations of the broader principles described herein.

The above is a summary of a number of the unique aspects, features, and advantages of the present invention. However, this summary is not exhaustive. Thus, these and other aspects, features, and advantages of the present invention will become more apparent from the following detailed description and the appended drawings, when considered in light of the claims provided herein.

### BRIEF DESCRIPTION OF THE DRAWINGS

In the drawings appended hereto like reference numerals denote like elements between the various drawings. While illustrative, the drawings are not drawn to scale. In the drawings:

FIG. 1 shows an overall description of a system providing personalized automated and autonomously initiated information delivery and chaperone service, in which arrows describe directions of data flow that result in database or display updates, according to one embodiment of the present invention.

FIG. 2 shows the process of taking a user through a set of steps executing an action, such as moving through an airport from arrival to take off, according to one embodiment of the present invention.

### DETAILED DESCRIPTION

In its most general sense, the present invention is a system and method for providing uninitiated (and optionally) secured wireless access by clients to information of service providers, such as, but not limited to, customers of travel service providers and users of health service providers. According to one embodiment, the present invention is of a system and method for providing an automated chaperone service. As used in the following description, “client” shall refer to a device or process, and “user” the individual operating the device or process, in a well-known client-server model.

According to the present invention there is provided a system which is composed of clients' mobile devices such as smart phones, personal digital assistants (PDAs), Pocket PCs, etc., local servers set in the local area network (LAN) of the site where the service is provided, such servers holding the user's information for the duration of the user's stay in the servers' vicinity, and a global server that holds the user information at all times. In addition the system contains interfaces that enable it to draw information from external sources. The client and the servers communicate with each other using, for example, the J2EE framework or another framework such as Spring, .NET HTTP or a proprietary framework built on such RPC technologies as RMI, SOAP, Servelets or any other remote access protocol known to those skilled in the art. Similarly the local servers take on the role of client when communicating with the global server in a similar framework as described above.

Security in the system is achieved by separating the different layers of the system. Clients, local servers, global server and external sources all communicate through encrypted channels and use constantly changing passwords to enable secure transmission. The client is not aware of the local server and database contained thereon (discussed in further detail below), and can retrieve information only by requesting it from the local server, similarly the local server is not aware of the global database and no server is aware of external databases. Passwords may be managed using LDAP or Kerberos, and Message encryption can use RSA or other encryption system.

According to the present invention there is provided a management system that transmits information automatically to a client. The system may initiate transmission of the information, or information may be received in response to very simple queries by the users. The system utilizes monitoring the location of a user within any area covered by the wireless network by communicating with the user's client device via a network of wireless access points. The automatically-transmitted information may be related to the user's geographical location, and/or a point in time, or it may provide information updates pertaining to a predefined user profile (such as an itinerary, etc. discussed further below).

This system is connected to at least one database, and information updates flow from the database to the system servers based upon trigger mechanisms located within the service provider operating the remote database. Upon detection of a change in the database, the trigger will send an update to the system's server, and this server will notify all relevant clients with regards to this change. This triggering mechanism is not germane to the point of novelty of the present invention, is well known to those skilled in the art, and is therefore not discussed further herein. However, the system's awareness of the location of individual users, and the awareness of the system to the current status of individual users in process of receiving service from a vendor, enables the system to demonstrate innate knowledge of information the user may require currently or in the very near future. This capability saves the user the need be familiar with the technicalities and general bureaucratic knowledge pertaining to the vendor service.

When more than one remote database exist, the system integrates the information relating to individual users so that a user receives information updates from all service vendors through one system server furthering seamless flow of information. The system has the ability to uniquely identify the user at any transaction requiring secured authentication and cross reference it with the system.

Computer servers in this system provide secured gateways to databases of different service providers such as, but not limited to, airlines, car rental companies, health institutes organizations, hospitals etc. The system also contains a proprietary database on which it maintains user profiles and personalized data. For example this system may have access to a passenger's driver's license information, medical information provided in advance (such as allergies, heart condition, recent medical treatments, etc.), airline travel itinerary, rental car reservation, and detailed site map. Client software on mobile platforms such as PDA devices or mobile phones equipped with secured authentication are able to uniquely identify the current user of the device by means of biometrical authentication such as finger print, retina signature, etc.

A person using such a mobile device is automatically identified when entering a zone covered by the present invention, for example by using a wireless system such as Wi-Fi access point without any need of human intervention. Below are several examples of implementations for such a system:
1. Conferences, Shows & Fairs: The system may direct users to conference halls, show rooms/desk counters or other places of interest based upon prior knowledge of subject of interest of the users combined with other criteria which may be defined (for example, length of queues). On fair grounds it may save time by directing users to rides fitting age/height limitations or preferred themes. It is an efficient tool for high volume market slicing into sections based upon intelligent characterizing of individuals based upon personal information they provide upon becoming a member of the system.
2. Hospitals: The system provides the ability to immediately identify an incapacitated patient arriving, along with critical personal health information and recent medical records. Such information can save lives by providing information regarding recent surgical procedures, heart condition, drug treatment or allergies without relying on a person's memory and fear of missing critical information due to the stressful emergency situation. Another service would be directing incoming visitors and patients to their desired offices/facilities/wards/patient's room, without requiring directions or assistance from the staff.
3. Airport—ticketing: Upon being detected, the managing system instantly pulls out the travel information from the airline database pertaining the specific itinerary of the passenger. After completing biometric authentication, the system may allow service providers such as airlines, to execute automatic self served check-in.
4. Airport—security and passenger traffic management: Airport security staff may be able to send personalized information updates, or redirect the passenger or group of passengers to desired locations such as when evacuating a building or when unexpectedly changing a gate of a connecting flight.
5. Airport—commuting within the facility: Upon being detected, the managing system instantly pulls out the travel information from the airline database pertaining the specific itinerary of the passenger and sends messages to the device at hand with itinerary updates, changes in flight schedule, or directions to the designated gate, exit or desk of service provider.
6. Airport—general: The system can act also as an “automated watch dog” timer, making sure that if a user is lagging behind schedule while shopping or resting somewhere, an alert will be sent to the user urging the expediting of the proceedings.

All the above is based on the itinerary and passenger information kept on, for example, but not limited to, the airline database and airport database. The Wi-Fi access point can provide accurate location of the user and support navigation within the building so that if a user becomes ill, a press on an emergency button or a triggering signal from blood pressure or heart monitoring device will send a signal of distress to an airport or other building emergency staff with the exact location of the patient and personal health information from a database containing recent illnesses, health status, medical treatments or allergies and sensitivities to medical drugs. Such information provided to emergency staff in real time can save critical time and substantially increase survival chances in case of heart attacks, strokes or acute allergy symptoms. Critical health information, given with an incapacitated person's consent in advance, can thereby promptly reach health staff in an emergency.

All the above services are being carried out automatically and without requiring any initiation on behalf of the user. The user gains in effect a chaperone guiding him through unfamiliar locations with an innate professional knowledge of all the travel needs to provide a sense of security and supply real-time information. There is no need for the user to upload any technical information or program any information or software. Upon reaching the final destination airport, the system will navigate the passenger to the car rental desk where an automatic vending machine equipped with a biometric authentication device will supply the car keys for checkout. It is a service which not only avoids queues, saves time, and provides security for the user, but also saves time and manpower for service providers. The system's awareness of the location and itinerary of the user enables it to predict what type of information the user may need at any given moment, and supply that information without being requested and without requiring triggering input (e.g., a request for information) from the user. It is a truly autonomous and independent system where the benefiting user is not part of the processing mechanism.

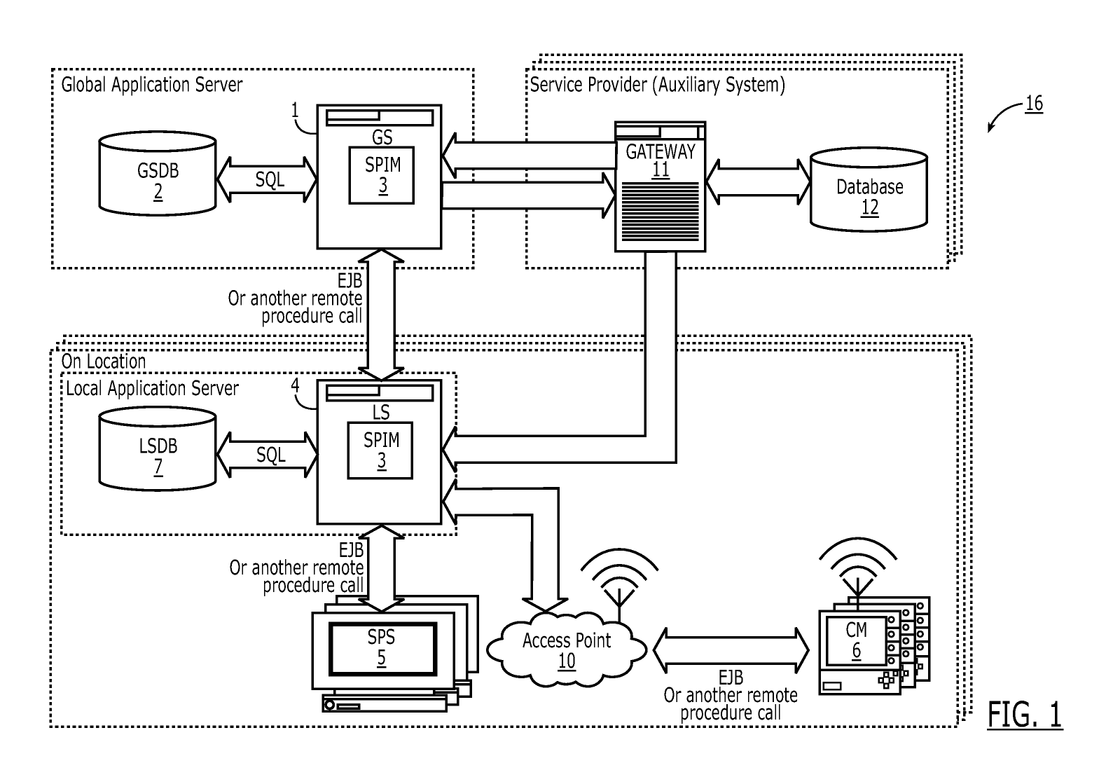

The principles and operation of the present invention may be better understood with reference to the drawings and the accompanying description. FIG. 1 is a partial schematic functional block diagram of the architecture of a preferred embodiment of a System 16 disclosed herein. System 16 may include additional or fewer components than those shown in FIG. 1, and thus FIG. 1 is simply an exemplary illustration of a system of the type disclosed herein. The components shown in FIG. 1 are: Global Server (GS) 1 that manages data, membership, etc. for all subscribing users at all times, depicted here as a single server machine, but may very well consist of multiple servers and other hardware and software; Global Server Database (GSDB) 2, the system's internal database; at least one local server (LS) 4 connected to Wi-Fi access points 10 for managing user data while in its vicinity; at least one Service Provider Interface Module block (SPIM) 3 included in both the GS 1 and the LS 4 for communicating with a Service Provider's database 12; an optional service provider's station (SPS) 5; and a client software module (CM) 6 running on a user's mobile device. CM 6, and optionally SPS 5, may contain a security feature and/or biometric authentication module, such as a finger print scan or retina scan (not shown), but because the nature and purpose of CM 6 and SPS 5 and their components are not germane to the point of novelty of the present invention, and indeed are well known to those skilled in the art, they will not be discussed further herein. The SPIM 3 block may include several interfaces to several different service providers, as it may be common that each provider has a proprietary and customized interface that the module needs to adhere to in order to be able to communicate with that provider.

A user who wishes to become a subscribing member of the system must first provide various information pertaining to authentication, such as I.D. number, driver's license details, finger print scan sample, retina scan sample, citizenship and/or other personal details. Arrangements for fees for access to the system may also be arranged at this point. Personal medical history and health condition may be provided if the user wishes to receive such support as well as definitions of the type of services the system shall provide. The information is then recorded on GSDB 2 as the user profile for possible use at a later time.

Business transactions such as purchasing flight tickets or renting a car are recorded in the GSDB 2, as part of an update procedure running on GS 1 which continuously receives via SPIM 3 triggered messages from participating service or goods vendors. The connection between the system server GS1 and the service provider's database may be established based upon various methods and protocols of communication such as SQL queries or triggering mechanisms from the service provider's database to GS1. The communication is secured appropriately, as may be defined and required by the service provider.

### Travel Itinerary Example

In one example, a user has, via aspects of the system, set up a travel itinerary, for example by purchasing tickets and renting a car through a participating service provider. System 16 is aware of the user's schedule through these purchases, and thus prepares in advance, prior to the expected time of arrival of the user at the airport, a local copy of the user's profile from GS 1, stored on local database LSDB 7. The profile includes the user's travel itinerary. Upon entering an area covered by System 16, preferably utilizing an existing Wi-Fi network, the user's CM 6 is registered and authenticated by LS 4. If the user arrives at the airport even before the system has prepared a local profile copy, LS 4 retrieves the user's profile and all information regarding the user's travel itinerary from GS 1 and GSDB 2. Using algorithms well known to those skilled in the art, LS 4 communicates with CM 6 and is able to determine its physical location within the area covered by the Wi-Fi network. System 16 is also aware of the physical layout, local travel pathways from point to point, estimated travel times for those local travel points, requirements for different forms of travel (e.g., shuttle bus, walk, etc.), fee-required access points (e.g., toll booths), authentication-required access points (e.g., security checkpoints), etc., and preferably path detours and potential delays, and is able to map out the required path for the user from the user's current location to the user's ultimate destination, including all intermediate paths.

System 16 is therefore capable of directing the user in the correct sequence from one stop point to another within the airport, such that the user is able to complete the entire process from, for example, E-ticketing, through check-in and receipt of a boarding pass from an E-ticketing SPS 5, through security check, up to accessing the departure gate to board an airplane. The user may be catching a connecting flight, while possibly collecting personal belongings in between gates, and eventually arriving at a rental car depot for automatically collecting car keys and executing a rental car check out (and later check in for return) using another SPS 5 at the same or a different destination location.

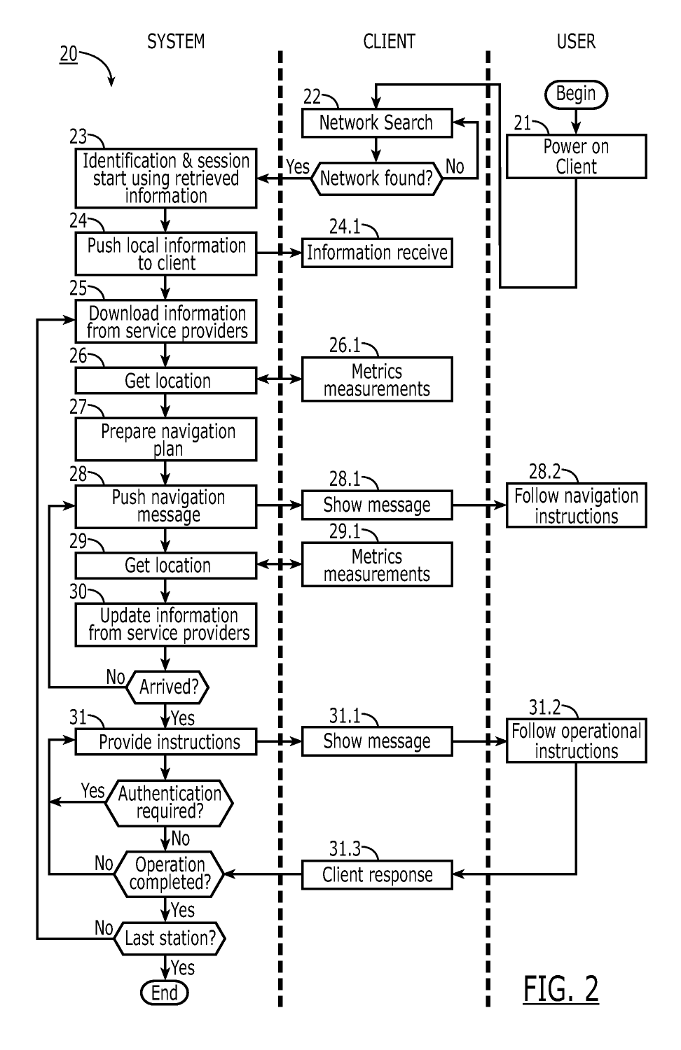

The following text refers to the flow chart 20 in FIG. 2. Flow chart 20 describes the process and the interaction between the user (a person) of a client (software running on a mobile device), and system 16. The figure is divided into three columns demonstrating the flow of activities executed by the system, the client, and the user respectively. The text refers to an example system located in an airport. The chart for local systems at different sites may look slightly different, but the principle of autonomous and self-initiated operation, are preserved. Reference numerals in parentheses that follow refer to steps in the process. The user switches on the client (21) upon arriving at the airport. The client then searches for a network connection (22). When a connection is established, the local server identifies the client and starts extracting information from the system's main database or from a readily available local copy regarding the user's personal identification parameters (23). The System then sends information to the client (24) such as messages directing and advising the user of what actions should be taken as well as directions to location where these actions must be executed, such as to execute the travel itinerary. Other information which may be sent to the user may be important phone numbers, and any other relevant information that is unique to the specific airport such as restaurant and coffee shop locations and whether they are currently open for service. The system is continuously updated with information from the service provider's data base such as E-ticket reservations and services as well as personalized data from the airline company to the local data base (25).

The system then finds the location of the user (26), according to measurements received from the client (26.1), using algorithms well known to those skilled in the art. The system can then automatically plan a route between locations that the user will have to pass through (27). In this example the order of navigation between locations is fixed, and cannot be exchanged due to the nature of the activities in airports that all activities are done in a specific sequenced order, but on sites other than airports the algorithm for picking the next station may be different. At an airport, for outgoing flights, the sequence of locations may be: car rental return, flight check in or automatic E-ticket check in (possibly using biometric authentication for expedited treatment), security check, border check, arrival at the gate, boarding the plane. For arrival flights the sequence of locations may be baggage claim, border check, customs check, rental car pickup (possibly using biometric authentication for expedited treatment).

The system pushes (sends without first requiring a request from the user) the navigation instructions to the client running on the mobile device (28), which shows the information to the user (28.1). The user follows the navigation instructions (28.2).

Messages pertaining to the travel needs and arrangements may be sent to the user at this time, such as, itinerary updates, changes to gate location or merging or flight numbers. While the user is in transit according to the navigation instruction of the system, the system keeps tracking his location (29, 29.1), and seeks any update information from the service provider (30) until the user arrives at the next location for further processing. In general, the system determines if any exceptions (e.g., traffic congestion, lengths of queues, changes in airline schedule, other user predefined preferences) to the execution of the procedures (e.g., itinerary) are presented, and if presented, the system determines what appropriate actions, including for example a change in itinerary, need to be taken by the user and communicates those actions to the client. In certain embodiments, the system may initiate changes in the local service provider to accommodate those changes, such as rebooking a flight, changing a restaurant reservation, etc. The system is therefore capable of dynamically changing elements of a procedure such as destinations, routes, etc., to accommodate real time changes in various parameters associated with the procedure.

It is emphasized that all messages are sent to the user in a timely manner so that they are in sync with the user's location and stage in the procedures being executed, and arrive when they are most relevant. This is achieved due to the fact that the system is aware of the current time, user location, and the required action to complete the procedures. The system may alert the user if it is noted that the user is becoming tardy for no apparent reason in a manner which may risk successful completion of the procedures.

The system provides instructions for the user upon arriving at a location where a process involving the user must be executed, by sending such instruction messages to the client (31). The client displays the received instructions to the user (31.1) as guidance at the location (31.2). At the location a processing station may require authentication; the system provides this information to the user together with detailed guidance regarding the actions and steps to be taken (31, 31.1, 31.2). Upon completion of the procedures, the system receives a response from the client or from the processing station (31.3) that the operation completed. The processing station in this case can also be a vending machine that supplies the rental car keys to the user. Upon process completion, the system checks whether or not this is the last station, and if so, the system finishes the navigation process. If not, it directs the user to the next location.

At any given time the system may loose connection with the client. The system will maintain and manage the session used for serving the user. The session contains vital information regarding the status of the user in the flow of processes being carried out. The session will allow the client to resume the flow upon reconnecting to the network, as long as the duration of disconnect is not beyond maximum timeout. If the period of disconnect will be beyond the specified timeout, the session will close with an update to the system that the user has not completed the proceeding successfully.

### Various Other Embodiments

The above describes a system for executing a travel itinerary through an airport or the like. However, it will be appreciated that substantially the same description applies to guided travel through train stations, retail malls, and other facilities. Furthermore, the system and method described above may be applied to many other forms of guided travel, where user location, user state, facility location, time and so forth are known. Indeed, travel in the sense of moving from one point to another, as facilitated by the invention disclosed herein, may include travel from one location to another or from one stage in a process to another. That is, travel may include modes of transportation such as airplane, train or automobile, but may also include travel within a single facility, such as a hospital, guidance and planning of scheduled rides, shows and fast pass queues of an amusement park customized to a user's preferences and limitations, guidance, customized planning, and real time updates regarding the status of shows, demonstrations, and speeches in a convention center, etc., without employing modes of transport. In the later case, the present invention facilitates moving from station to station by providing any of the following directions to the user (e.g., where admitting is in a hospital), directions to the facility operator (e.g., where to take the patient), user data (e.g., patient information such as allergies or recent medical procedures), procedure data (e.g., whether to have a patient sitting upright or laying down), etc. Therefore, what is disclosed herein is a system providing uninitiated wireless access by a client to information of a service provider which includes a subsystem for determining the location of the client, a subsystem for determining information, based on the determined location of the client, of potential need to the client in respect of procedures which the client is in the process of executing, and a system for pushing the information to the client. The system may further include a subsystem for providing an estimation, based on a procedure the client is currently executing, of at least one next procedure the client is likely to execute, and in which the subsystem for determining information uses said estimation when determining the information of potential need to the client.

It will be appreciated that the methods, in the form of instructions having a sequence, syntax, and content, of the present invention may be stored on (or equivalently, in) any of a wide variety of computer-readable media such as magnetic media, optical media, magneto-optical media, electronic media (e.g., solid state ROM or RAM), etc., the form of which media not limiting the scope of the present invention. A computer reading said media is operable to either transfer (e.g., download) said instructions thereto and then operate on those instructions, or cause said instructions to be read from the media and operate in response thereto. Furthermore, devices (e.g., a reader) for accessing the instructions on said media may be contained within or connected directly to the computer on which those instructions operate, or may be connected via a network or other communication pathway to said computer.

While a plurality of preferred exemplary embodiments have been presented in the foregoing detailed description, it should be understood that a vast number of variations exist, and these preferred exemplary embodiments are merely representative examples, and are not intended to limit the scope, applicability or configuration of the invention in any way. Rather, the foregoing detailed description provides those of ordinary skill in the art with a convenient guide for implementation of the invention, by way of examples, and contemplates that various changes in the functions and arrangements of the described embodiments may be made without departing from the spirit and scope of the invention defined by the claims thereto.

What is claimed is:

1. A system providing uninitiated wireless access by a client to information of a service provider, comprising:
a subsystem for determining the location of the client;
a subsystem for determining information, based on the determined location of the client, of potential need to the client in respect of procedures which the client is in the process of executing; and
a system for pushing the information to the client.

2. The system of claim 1, further comprising:
a subsystem for providing an estimation, based on a procedure the client is currently executing, of at least one next procedure the client is likely to execute; and
said subsystem for determining information using said estimation when determining the information of potential need to the client.

3. A system for providing procedural information to a client, comprising:
at least one wireless network;
at least one server;
at least one client having uninitiated access to the network; and
a subsystem for causing the server to push information to the client without requests for information from the client, said information based upon:
client location; and
time at which the client executes a procedure.

4. The system of claims 3, further comprising:
a subsystem for determining a travel itinerary of the client;
a subsystem for determining the current date and time;
a subsystem for determining the location of the client; and
wherein said information is related to the travel itinerary of the client and further
wherein said at least one server is communicatively connected to a plurality of databases, each said database being a source of said information which may be pushed to the client.

5. The system of claim 3, further comprising a subsystem for providing uninitiated guidance to the client pertaining to its location, the current date and time, and relevant to procedures which the user is in the process of executing.

6. The system of claim 5, wherein said guidance is directional, geographic guidance such that the client may navigate from one location to another in the execution of the itinerary.

7. The system of claims 6, further comprising a subsystem for providing knowledge and real-time information and guidance for executing actions without requiring initiation on behalf of the client, and without requiring the client to upload any technical information or program any information or software specific to that itinerary.

8. The system of claims 3, further comprising a subsystem for initiating transmission of information and providing personalized guidance to the client based upon generalized sequences of operations which are customized automatically to fit the itinerary.

9. The system of claim 3, further comprising a subsystem for transmitting a distress call to emergency staff, identifying the location of the client within a bounded area and providing personal medical information related to the client.

10. A system for forecasting the arrival of a client to a location covered by its wireless network, and prepare in advance data and information pertaining to the client's schedule and procedures to be executed on location upon arrival, comprising:
a wireless broadcasting facility;
a server containing a travel itinerary of the client;
a subsystem for estimating the future arrival time of the client at a location;
a subsystem for determining the data and information pertaining to the client's schedule and procedures to be executed on location upon arrival based upon the itinerary, the estimated future time of arrival, and information relating to characteristics of the client; and
a subsystem for causing said data and information to be sent by said wireless broadcasting facility from said server to said client.

11. A method for providing a virtual chaperone service, comprising:
monitoring the location of a user's mobile device within an area covered by a wireless system; and
automatically initiating transmission of information related to the user's geographical location to the user's mobile device pertaining to a procedure associated with a predefined user's profile, to thereby present said information on said user's mobile device and offer assistance to the user in executing said procedure.

12. The method of claim 11, wherein said predefined user's profile is a travel itinerary.

13. The method of claims 11, further comprising the step of providing automatic self served check-in to a service.

14. The method of claim 13 wherein the service is an airline flight.

15. The method of claim 13 wherein the service is a transaction with a vehicle rental service.

16. The method of claim 15, wherein the service is a transaction relating to hospital admittance.

17. The method of claim 13, wherein the service is guidance and planning scheduled rides, shows and pass queues of an amusement park customized to a user's preferences and limitations.

18. The method of claim 13 wherein the service is guidance, customized planning, and real time updates regarding the status of shows, demonstrations, and speeches in a convention center.

19. The method of claim 11, wherein said system is capable of dynamically changing destinations and routes to destinations based on real time variations of parameters.

20. The method of claim 19, wherein said parameters are selected from the group consisting of:
traffic congestion, lengths of queues, changes in airline schedule, and user predefined preferences.

21. The method of claim 11, further comprising the step of transmitting a distress call to emergency staff identifying the location of the user within a bounded area and providing personal medical information related to the user.

22. The method of claim 20, further comprising the steps of:
determining whether an exception to the execution of the itinerary, procedures, and actions is present; and
when such an exception is present, sending an alert to the user's mobile device providing an indication of appropriate actions which need to be taken by the user.

23. The method of claim 22, wherein said exception is a determination that insufficient time is presently allocated for a user to make a connecting flight.

24. The method of claim 22, wherein said exception is a determination that a flight on which a user is presently scheduled to depart is sufficiently late such that the user will not be able to make a connecting flight.
